(19) United States
(12) Patent Application Publication
(10) Pub. No.: US 2013/0236741 A1
(43) Pub. Date: Sep. 12, 2013

(54) VIBRATION-DAMPING COMPOSITE MATERIAL

(71) Applicant: HITACHI CABLE, LTD., Tokyo (JP)

(72) Inventors: Kazuma KUROKI, Hitachinaka (JP); Hiromitsu KURODA, Hitachi (JP)

(73) Assignee: HITACHI CABLE, LTD., Tokyo (JP)

(21) Appl. No.: 13/785,282

(22) Filed: Mar. 5, 2013

(30) Foreign Application Priority Data
Mar. 8, 2012 (JP) 2012-051149

(51) Int. Cl. F16F 7/00

(52) U.S. Cl. CPC F16F 7/00
USPC 428/659

(57) ABSTRACT

A vibration-damping composite material includes a clad material that includes a base material includes a zinc-aluminum alloy and metal layers each including a ferritic stainless steel on both surfaces of the base material. A total thickness of the metal layers is not less than 40% and not more than 80% of the thickness of the clad material.

The present application is based on Japanese patent application No. 2012-051149 filed on Mar. 8, 2012, the entire contents of which are incorporated herein by reference.

### BACKGROUND OF THE INVENTION

1. Field of the Invention

The invention relates to a composite material used in industrial machinery, consumer appliances and other various fields and, in particular, to a composite material having a vibration-damping property.

2. Description of the Related Art

A composite material having a vibration-damping property, so-called vibration-damping composite material, is considered to be used in industrial machinery, consumer appliances and other various fields. For example, a vehicle has a lot of vibration sources which generate vibration, including a drive-train such as engine. Therefore, it is desirable that a composite material having the vibration-damping property be used for a vibration source per se or peripheral equipments thereof to suppress generation of vibration itself or influence of the vibration on the peripheral equipments as much as possible.

A laminated damping steel sheet is a damping material having such a vibration-damping function (e.g., JP-A-S64-014027). The laminated damping steel sheet has a structure in which a sheet made of a resin is arranged between two steel sheets such that the resin sandwiched between the two steel sheets acts to absorb vibration.

Another example is a clad spring material having a three-layer structure in which copper layers are provided on both surfaces of stainless steel (e.g., JP-A-H02-217184). The three-layer clad spring material has a non-joined portion formed at an interface between the stainless steel and the copper layer so that vibration is absorbed at the non-joined portion.

### SUMMARY OF THE INVENTION

In various fields including the industrial machinery field and the consumer appliance field, a composite material is required to have sufficient mechanical strength to withstand vibration and also to have a good vibration-damping property even in use under a high-temperature environment.

For example, in a vehicle, it is expected that temperature of a vibration source or a portion affected by vibration becomes high while the vehicle is moving. Accordingly, it is desirable to have the good vibration-damping property not only simply in ambient temperature but also under the high-temperature environment. It is obvious that such a composite material having the good vibration-damping property under the high-temperature environment is demanded not only for a vehicle but also in various fields.

Accordingly, it is an object of the invention to provide a vibration-damping composite material that offers a good vibration-damping property and mechanical strength under the high-temperature environment.

### (1) According to One Embodiment of the Invention, a Vibration-Damping Composite Material Comprises:

a clad material that comprises a base material comprising a zinc-aluminum alloy and metal layers each comprising a ferritic stainless steel on both surfaces of the base material,

wherein a total thickness of the metal layers is not less than 40% and not more than 80% of the thickness of the clad material.

In the above embodiment (1) of the invention, the following modifications and changes can be made.

(i) The metal layers comprise a same ferritic stainless steel.

(ii) The metal layers have a same thickness.

(iii) The metal layer comprises one of SUS430, SUS405, SUS409 and SUS430LX.

(iv) The clad material has a thickness of not less than 1 mm and not more than 5 mm.

(v) The base material comprises an alloy of Zn-22 mass % Al.

(vi) The total thickness of the metal layers is not less than 40% and not more than 65% of the thickness of the clad material.

### Effects of the Invention

According to one embodiment of the invention, a vibration-damping composite material can be provided that offers a good vibration-damping property and mechanical strength under the high-temperature environment.

### BRIEF DESCRIPTION OF THE DRAWINGS

Next, the present invention will be explained in more detail in conjunction with appended drawings, wherein:

FIG. 1 is a cross sectional view showing a vibration-damping composite material of the present invention; and

FIG. 2 is an explanatory diagram illustrating a method of manufacturing the vibration-damping composite material of the invention.

### DETAILED DESCRIPTION OF THE PREFERRED EMBODIMENTS

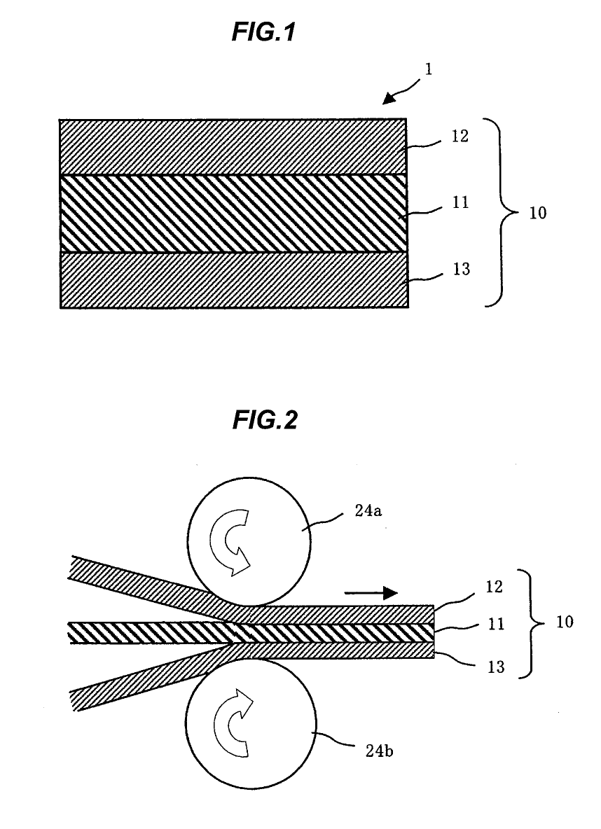

A vibration-damping composite material in an embodiment of the invention will be described below in conjunction with the drawings. FIG. 1 is a cross sectional view showing a vibration-damping composite material 1 of the invention.

The vibration-damping composite material 1 in the present embodiment is formed of a clad material 10 having a base material 11, a first metal layer 12 laminated on a surface of the base material 11 and a second metal layer 13 laminated on a surface of the base material 11 opposite to the surface on which the first metal layer 12 is laminated.

The base material 11 is formed of a zinc-aluminum alloy, e.g., Zn-22 mass % Al, etc. The alloy formed of Zn-22 mass % Al is relatively cheap and has an excellent vibration-damping property at a high temperature. Therefore, the zinc-aluminum alloy is used for the base material 11 by taking into consideration the use of the clad material 10 at a high temperature of, e.g., not less than 200° C. and it is thus possible to obtain the vibration-damping composite material 1 having a good vibration-damping property under a high-temperature environment of not less than 200° C.

The first metal layer 12 and the second metal layer 13 have a function of exhibiting the good vibration-damping property and strength at the high temperature and are formed of, e.g., a ferritic stainless steel. The ferritic stainless steel includes, e.g., SUS430 (Fe-18 mass % Cr), SUS405 (Fe-13 mass % Cr—Al), SUS409 (Fe-13 mass % Cr—Ti) and SUS430LX (Fe-18 mass % Cr—Ti or Fe-18 mass % Cr—Nb), etc.

The ferritic stainless steels mentioned above are metal excellent in mechanical strength, corrosion resistance and vibration-damping property. Therefore, providing such a metal on both surfaces of the base material 11 allows mechanical strength required for the clad material 10 such as tensile strength to be ensured, the clad material 10 to exhibit the good vibration-damping property at the high temperature and characteristic variation thereof to fall within a small range.

The first metal layer 12 and the second metal layer 13 may be formed of either the same type of ferritic stainless steel or different types of ferritic stainless steels as long as a ferritic stainless steel is used. Use of the same type of ferritic stainless steel for the first metal layer 12 and the second metal layer 13 especially facilitates a clad rolling process. Accordingly, in case of performing the clad rolling process, warping on the clad material 10 caused by pressure during the clad rolling process is less likely to occur. Furthermore, use of the same type of ferritic stainless steel with the same thickness as the first metal layer 12 and the second metal layer 13 allows the same characteristics to be exhibited on front and back surfaces of the clad material 10, which allows a user to use the composite material without checking front and back. In addition, the user does not need to check the front and back sides of the vibration-damping composite material when processing is carried out based on the intended use. For example, in case of joining the clad material 10 to another member, it is possible to prevent the user from joining the other member to a wrong surface.

Thickness of Each Layer of Clad Material

The first metal layer 12 and the second metal layer 13 which cover the both surfaces of the base material 11 preferably have the same thickness. By using the metal sheet having the same thickness to form the first metal layer 12 and the second metal layer 13, it is possible to reduce warping of the clad material 10 formed by the clad rolling process.

In addition, the total thickness of the metal layers (the total thickness of the first metal layer 12 and the second metal layer 13) provided on the both surfaces of the base material 11 formed of a zinc-aluminum alloy is desirably within a range of not less than 40% and not more than 80% with respect to the thickness of the clad material 10. When the total thickness of the metal layers is less than 40% of the thickness of the clad material 10, tensile strength, etc., decreases under the high-temperature environment of not less than 200° C. and it is difficult to obtain sufficient mechanical strength as a composite material. In addition, when a ratio of the metal layers to the clad material 10 is reduced, it is difficult to maintain quality during the clad rolling process. On the other hand, when the total thickness of the metal layers is greater than 80% of the thickness of the clad material 10, a ratio of the base material 11 to the clad material 10 is small. Therefore, a vibration-damping effect of the base material 11 is not sufficiently exhibited and it is difficult to obtain the good vibration-damping property at a high temperature of not less than 200° C.

Regarding the thickness of the metal layer formed of a ferritic stainless steel and that of the base material 11, variation in a sheet thickness ratio of the constituent metal sheets is very small before and after the clad rolling process and can be totally ignored in view of accuracy related to characteristics, etc. Therefore, a ratio of the thickness of the base material 11 to that of the first metal layer 12 to that of the second metal layer 13 after the clad rolling process can be regarded as the same as a sheet thickness ratio of the respective metal sheets before the clad rolling process.

Next, the thickness of the clad material 10 formed by the clad rolling process will be described. The thickness of the clad material 10 formed by the clad rolling process is desirably not less than 1 mm and not more than 5 mm. When the thickness of the clad material 10 is less than 1 mm, vibration of the clad material 10 is too large and the vibration-damping property may be less likely to be exhibited. In more detail, it is considered that, since a zinc-aluminum alloy is used as the base material 11 and a ferritic stainless steel as the metal layers in the clad material 10 of the invention, the base material 11 and the metal layers act as a rigid body to some extent against mechanical vibration and act to convert vibration energy into other energy such as heat to suppress vibration. Therefore, if the thickness of the clad material 10 is small such as less than 1 mm, there is a possibility that the entire clad material 10 wobbles and the above-mentioned effects are reduced.

On the other hand, the thickness of the material prepared before the clad rolling process needs to be greater than 10 mm when forming the clad material 10 having a thickness of greater than 5 mm by the clad rolling process, however, this requires a large-scale rolling apparatus and also raises a concern of a decrease in productivity caused by a shortened roll life due to overload, etc. In addition, for the thick clad material 10, a thick sheet material is required as a metal sheet for forming each layer. Therefore, it is difficult to obtain the metal sheet, which may result in an expensive material.

Method of Manufacturing Vibration-Damping Composite Material

Next, a method of manufacturing the vibration-damping composite material 1 will be described in reference to FIG. 2. A clad material having a three-layer structure shown in FIG. 1 is a laminated sheet composed of three metal sheets attached to each other by cold rolling. The laminated sheet is further processed by rolling so as to have a predetermined thickness, if required. Such a series of processes is described as a clad rolling process in the present embodiment.

A specific example is as follows. Metal sheets of ferritic stainless steel respectively constituting the first metal layer 12 and the second metal layer 13 and a metal sheet of a zinc-aluminum alloy constituting the base material 11 are prepared. Surfaces of the both types of metal sheets respectively to be bonding surfaces are cleaned and then polished by a metal brush. Subsequently, pressure-welding rolling is performed by processing rolls 24 (24a and 24b) in a state that the bonding surfaces face each other, as shown in FIG. 2. Here, rolling reduction in the pressure-welding rolling is desirably around 60%. Such a level of rolling reduction provides good adhesion of the metal sheets to each other and it is thus possible to obtain a robust clad material 10. After the rolling process as described above, finish rolling for finishing the material with a predetermined thickness is performed if required.

If work hardening due to the rolling process is remarkable, an annealing process should be added after the clad rolling process when manufacturing the vibration-damping composite material. Here, an annealing temperature in the annealing process is, e.g., 1000° C. and annealing time is, e.g., about 5 minutes.

Considering, e.g., a liquid phase of zinc-aluminum alloy which constitutes the base material 11, use environment of a product to which the vibration-damping composite material 1 of the present embodiment is applied is desirably not more than 260° C.

### EXAMPLES

Examples will be described below.

In each of Examples 1 to 9 and Comparative Examples 1 to 5 described below, a metal sheet of zinc-aluminum alloy was prepared and metal sheets of ferritic stainless steel were then attached to both surfaces thereof by cold rolling, thereby making a 1.8 mm-thick clad material 10 in which the first metal layer 12 and the second metal layer 13 are laminated on the both surfaces of the base material 11. Note that, a thickness ratio of the base material 11 in each Example is calculated based on a ratio of the sheet thickness of zinc-aluminum alloy to the total sheet thickness of the three-layer structure before rolling.

### Example 1

A 3.0 mm-thick metal sheet of Zn-22 mass % Al constituting the base material 11 and two 1.0 mm-thick metal sheets of SUS430 constituting the first metal layer 12 and the second metal layer 13 were prepared. Then, surfaces of the metal sheets, which are to be facing surfaces when being stacked to form a three-layer structure shown in FIG. 1, were cleaned and brushed. After that, the metal sheets of SUS430 were respectively attached to the both surfaces of the metal sheet of Zn-22 mass % Al so that the cleaned surfaces were exposed and cold rolling was performed in the air by the processing rolls 24, thereby making a vibration-damping composite material formed of the 1.8 mm-thick clad material 10 in which the first metal layer 12 and the second metal layer 13 are laminated on the both surfaces of the base material 11. Note that, the total thickness of the metal layers is 40% of the thickness of the clad material 10.

### Example 2

A 2.24 mm-thick metal sheet of Zn-22 mass % Al constituting the base material 11 and two 1.38 mm-thick metal sheets of SUS430 constituting the first metal layer 12 and the second metal layer 13 were prepared. Then, surfaces of the metal sheets, which are to be facing surfaces when being stacked to form a three-layer structure shown in FIG. 1, were cleaned and brushed. After that, the metal sheets of SUS430 were respectively attached to the both surfaces of the metal sheet of Zn-22 mass % Al so that the cleaned surfaces were exposed and cold rolling was performed in the air by the processing rolls 24, thereby making a vibration-damping composite material formed of the 1.8 mm-thick clad material 10 in which the first metal layer 12 and the second metal layer 13 are laminated on the both surfaces of the base material 11. Note that, the total thickness of the metal layers is 55% of the thickness of the clad material 10.

### Example 3

A 2.75 mm-thick metal sheet of Zn-22 mass % Al constituting the base material 11 and two 1.13 mm-thick metal sheets of SUS405 constituting the first metal layer 12 and the second metal layer 13 were prepared. Then, surfaces of the metal sheets, which are to be facing surfaces when being stacked to form a three-layer structure shown in FIG. 1, were cleaned and brushed. After that, the metal sheets of SUS405 were respectively attached to the both surfaces of the metal sheet of Zn-22 mass % Al so that the cleaned surfaces were exposed and cold rolling was performed in the air by the processing rolls 24, thereby making a vibration-damping composite material formed of the 1.8 mm-thick clad material 10 in which the first metal layer 12 and the second metal layer 13 are laminated on the both surfaces of the base material 11. Note that, the total thickness of the metal layers is 45% of the thickness of the clad material 10.

### Example 4

A 2.5 mm-thick metal sheet of Zn-22 mass % Al constituting the base material 11 and two 1.25 mm-thick metal sheets of SUS405 constituting the first metal layer 12 and the second metal layer 13 were prepared. Then, surfaces of the metal sheets, which are to be facing surfaces when being stacked to form a three-layer structure shown in FIG. 1, were cleaned and brushed. After that, the metal sheets of SUS405 were respectively attached to the both surfaces of the metal sheet of Zn-22 mass % Al so that the cleaned surfaces were exposed and cold rolling was performed in the air by the processing rolls 24, thereby making a vibration-damping composite material formed of the 1.8 mm-thick clad material 10 in which the first metal layer 12 and the second metal layer 13 are laminated on the both surfaces of the base material 11. Note that, the total thickness of the metal layers is 50% of the thickness of the clad material 10.

### Example 5

A 1.75 mm-thick metal sheet of Zn-22 mass % Al constituting the base material 11 and two 1.63 mm-thick metal sheets of SUS409 constituting the first metal layer 12 and the second metal layer 13 were prepared. Then, surfaces of the metal sheets, which are to be facing surfaces when being stacked to form a three-layer structure shown in FIG. 1, were cleaned and brushed. After that, the metal sheets of SUS409 were respectively attached to the both surfaces of the metal sheet of Zn-22 mass % Al so that the cleaned surfaces were exposed and cold rolling was performed in the air by the processing rolls 24, thereby making a vibration-damping composite material formed of the 1.8 mm-thick clad material 10 in which the first metal layer 12 and the second metal layer 13 are laminated on the both surfaces of the base material 11. Note that, the total thickness of the metal layers is 65% of the thickness of the clad material 10.

### Example 6

A 2.0 mm-thick metal sheet of Zn-22 mass % Al constituting the base material 11 and two 1.5 mm-thick metal sheets of SUS409 constituting the first metal layer 12 and the second metal layer 13 were prepared. Then, surfaces of the metal sheets, which are to be facing surfaces when being stacked to form a three-layer structure shown in FIG. 1, were cleaned and brushed. After that, the metal sheets of SUS409 were respectively attached to the both surfaces of the metal sheet of Zn-22 mass % Al so that the cleaned surfaces were exposed and cold rolling was performed in the air by the processing rolls 24, thereby making a vibration-damping composite material formed of the 1.8 mm-thick clad material 10 in which the first metal layer 12 and the second metal layer 13 are laminated on the both surfaces of the base material 11. Note that, the total thickness of the metal layers is 60% of the thickness of the clad material 10.

### Example 7

A 1.5 mm-thick metal sheet of Zn-22 mass % Al constituting the base material 11 and two 1.75 mm-thick metal sheets of SUS430 constituting the first metal layer 12 and the second metal layer 13 were prepared. Then, surfaces of the metal sheets, which are to be facing surfaces when being stacked to form a three-layer structure shown in FIG. 1, were cleaned and brushed. After that, the metal sheets of SUS430 were respectively attached to the both surfaces of the metal sheet of Zn-22 mass % Al so that the cleaned surfaces were exposed and cold rolling was performed in the air by the processing rolls 24, thereby making a vibration-damping composite material formed of the 1.8 mm-thick clad material 10 in which the first metal layer 12 and the second metal layer 13 are laminated on the both surfaces of the base material 11. Note that, the total thickness of the metal layers is 70% of the thickness of the clad material 10.

### Example 8

A 1.24 mm-thick metal sheet of Zn-22 mass % Al constituting the base material 11 and two 1.88 mm-thick metal sheets of SUS405 constituting the first metal layer 12 and the second metal layer 13 were prepared. Then, surfaces of the metal sheets, which are to be facing surfaces when being stacked to form a three-layer structure shown in FIG. 1, were cleaned and brushed. After that, the metal sheets of SUS405 were respectively attached to the both surfaces of the metal sheet of Zn-22 mass % Al so that the cleaned surfaces were exposed and cold rolling was performed in the air by the processing rolls 24, thereby making a vibration-damping composite material formed of the 1.8 mm-thick clad material 10 in which the first metal layer 12 and the second metal layer 13 are laminated on the both surfaces of the base material 11. Note that, the total thickness of the metal layers is 75% of the thickness of the clad material 10.

### Example 9

A 1.0 mm-thick metal sheet of Zn-22 mass % Al constituting the base material 11 and two 2.0 mm-thick metal sheets of SUS405 constituting the first metal layer 12 and the second metal layer 13 were prepared. Then, surfaces of the metal sheets, which are to be facing surfaces when being stacked to form a three-layer structure shown in FIG. 1, were cleaned and brushed. After that, the metal sheets of SUS405 were respectively attached to the both surfaces of the metal sheet of Zn-22 mass % Al so that the cleaned surfaces were exposed and cold rolling was performed in the air by the processing rolls 24, thereby making a vibration-damping composite material formed of the 1.8 mm-thick clad material 10 in which the first metal layer 12 and the second metal layer 13 are laminated on the both surfaces of the base material 11. Note that, the total thickness of the metal layers is 80% of the thickness of the clad material 10.

### Comparative Example 1

A 4.5 mm-thick metal sheet of Zn-22 mass % Al constituting the base material 11 and two 0.25 mm-thick metal sheets of SUS430 constituting the first metal layer 12 and the second metal layer 13 were prepared. Then, surfaces of the metal sheets, which are to be facing surfaces when being stacked to form a three-layer structure shown in FIG. 1, were cleaned and brushed. After that, the metal sheets of SUS430 were respectively attached to the both surfaces of the metal sheet of Zn-22 mass % Al so that the cleaned surfaces were exposed and cold rolling was performed in the air by the processing rolls 24, thereby making a vibration-damping composite material formed of the 1.8 mm-thick clad material 10 in which the first metal layer 12 and the second metal layer 13 are laminated on the both surfaces of the base material 11. Note that, the total thickness of the metal layers is 10% of the thickness of the clad material 10.

### Comparative Example 2

A 4.0 mm-thick metal sheet of Zn-22 mass % Al constituting the base material 11 and two 0.5 mm-thick metal sheets of SUS430 constituting the first metal layer 12 and the second metal layer 13 were prepared. Then, surfaces of the metal sheets, which are to be facing surfaces when being stacked to form a three-layer structure shown in FIG. 1, were cleaned and brushed. After that, the metal sheets of SUS430 were respectively attached to the both surfaces of the metal sheet of Zn-22 mass % Al so that the cleaned surfaces were exposed and cold rolling was performed in the air by the processing rolls 24, thereby making a vibration-damping composite material formed of the 1.8 mm-thick clad material 10 in which the first metal layer 12 and the second metal layer 13 are laminated on the both surfaces of the base material 11. Note that, the total thickness of the metal layers is 20% of the thickness of the clad material 10.

### Comparative Example 3

A 4.24 mm-thick metal sheet of Zn-22 mass % Al constituting the base material 11 and two 0.38 mm-thick metal sheets of SUS405 constituting the first metal layer 12 and the second metal layer 13 were prepared. Then, surfaces of the metal sheets, which are to be facing surfaces when being stacked to form a three-layer structure shown in FIG. 1, were cleaned and brushed. After that, the metal sheets of SUS405 were respectively attached to the both surfaces of the metal sheet of Zn-22 mass % Al so that the cleaned surfaces were exposed and cold rolling was performed in the air by the processing rolls 24, thereby making a vibration-damping composite material formed of the 1.8 mm-thick clad material 10 in which the first metal layer 12 and the second metal layer 13 are laminated on the both surfaces of the base material 11. Note that, the total thickness of the metal layers is 15% of the thickness of the clad material 10.

### Comparative Example 4

A 3.74 mm-thick metal sheet of Zn-22 mass % Al constituting the base material 11 and two 0.63 mm-thick metal sheets of SUS409 constituting the first metal layer 12 and the second metal layer 13 were prepared. Then, surfaces of the metal sheets, which are to be facing surfaces when being stacked to form a three-layer structure shown in FIG. 1, were cleaned and brushed. After that, the metal sheets of SUS409 were respectively attached to the both surfaces of the metal sheet of Zn-22 mass % Al so that the cleaned surfaces were exposed and cold rolling was performed in the air by the processing rolls 24, thereby making a vibration-damping composite material formed of the 1.8 mm-thick clad material 10 in which the first metal layer 12 and the second metal layer 13 are laminated on the both surfaces of the base material 11. Note that, the total thickness of the metal layers is 25% of the thickness of the clad material 10.

### Comparative Example 5

A 0.74 mm-thick metal sheet of Zn-22 mass % Al constituting the base material 11 and two 2.13 mm-thick metal sheets of SUS409 constituting the first metal layer 12 and the second metal layer 13 were prepared. Then, surfaces of the metal sheets, which are to be facing surfaces when being stacked to form a three-layer structure shown in FIG. 1, were cleaned and brushed. After that, the metal sheets of SUS409 were respectively attached to the both surfaces of the metal sheet of Zn-22 mass % Al so that the cleaned surfaces were exposed and cold rolling was performed in the air by the processing rolls 24, thereby making a vibration-damping composite material formed of the 1.8 mm-thick clad material 10 in which the first metal layer 12 and the second metal layer 13 are laminated on the both surfaces of the base material 11. Note that, the total thickness of the metal layers is 85% of the thickness of the clad material 10.

### Comparative Example 6

A 0.4 mm-thick resin sandwiched between two 0.7 mm-thick soft steel sheets was hot-pressed, thereby forming a laminated damping steel sheet having a total thickness of 1.8 mm.

Tests of vibration-damping property and tensile strength under a high-temperature environment were conducted on each of the vibration-damping composite materials in Examples 1 to 9 and Comparative Examples 1 to 6. Here, a damping coefficient is used as the numerical value indicating the vibration-damping property.

Vibration-Damping Property

The vibration-damping composite materials formed in Examples 1 to 9 and Comparative Examples 1 to 5 and the laminated damping steel sheet formed in Comparative Example 6 were cut into a predetermined size, thereby making respective test pieces. After that, each test piece was heated to 250° C. to test the vibration-damping property. After heating the test piece, the test of the vibration-damping property was conducted by a one-end fixing steady-state vibration method in accordance with JIS G 0602 “Test methods for vibration-damping property in laminated damping steel sheets of constrained type” and the damping coefficient of the test piece was measured. Based on the local maximum value of n^{th} amplitude (Xₙ) and the local maximum value of (n+1)^{th} amplitude (Xₙ₊₁) which are adjacent to each other in an attenuation curve obtained by the test, a natural logarithmic value thereof (logarithmic decrement Δ=logₑ (Xₙ/Xₙ₊₁), (n≧1)) is derived and the derived natural logarithmic value (logarithmic decrement) is expressed in percentage, thereby obtaining the damping coefficient.

Tensile Strength

The vibration-damping composite materials formed in Examples 1 to 9 and Comparative Examples 1 to 5 and the laminated damping steel sheet formed in Comparative Example 6 were cut into a predetermined size, thereby making respective test pieces. After that, the tensile strength was tested while heating each test piece to 250° C. The tensile strength test was conducted in accordance with JIS G 0567 “Method of elevated temperature tensile test for steels and heat-resisting alloys”.

Table 1 shows the test results of Examples 1 to 9 and Comparative Examples 1 to 6. In Table 1, a ratio of the total thickness of the metal sheets with respect to the thickness of the clad material 10 is shown as “Thickness ratio of Metal layer (%)”. Then, the sample having a damping coefficient of not less than 7.0% and tensile strength of not less than 200 MPa was evaluated as “0” (passed) and the sample having a damping coefficient of less than 7.0% and tensile strength of less than 200 MPa was evaluated as “x” (failed).

TABLE 1

| | | | | | Tensile | |
|---|---|---|---|---|---|---|
| | | | Thickness | Damping | strength | |
| | | | ratio of | coefficient | (at | |
| | | | metal | (at | 250° C., | |
| | | Laminate structure | layer (%) | 250° C., %) | MPa) | Evaluation |
| Examples | 1 | SUS430/Zn—22Al/SUS430 | 40 | 11.8 | 205 | ◯ |
| | 2 | SUS430/Zn—22Al/SUS430 | 55 | 12.9 | 265 | ◯ |
| | 3 | SUS405/Zn—22Al/SUS405 | 45 | 15.1 | 225 | ◯ |
| | 4 | SUS405/Zn—22Al/SUS405 | 50 | 14.0 | 245 | ◯ |
| | 5 | SUS409/Zn—22Al/SUS409 | 65 | 10.7 | 304 | ◯ |
| | 6 | SUS409/Zn—22Al/SUS409 | 60 | 11.8 | 284 | ◯ |
| | 7 | SUS430/Zn—22Al/SUS430 | 70 | 9.6 | 323 | ◯ |
| | 8 | SUS405/Zn—22Al/SUS405 | 75 | 8.5 | 343 | ◯ |
| | 9 | SUS405/Zn—22Al/SUS405 | 80 | 7.4 | 363 | ◯ |
| Comparative | 1 | SUS430/Zn—22Al/SUS430 | 10 | 23.9 | 69 | X |
| Examples | 2 | SUS430/Zn—22Al/SUS430 | 20 | 20.6 | 127 | X |
| | 3 | SUS405/Zn—22Al/SUS405 | 15 | 21.7 | 108 | X |
| | 4 | SUS409/Zn—22Al/SUS409 | 25 | 19.5 | 147 | X |
| | 5 | SUS409/Zn-22Al/SUS409 | 85 | 6.3 | 382 | X |
| | 6 | Laminated damping steel | — | 0.9 | 440 | X |
| | | sheet | | | | |

As shown in the evaluation results in Table 1, it is understood that the vibration-damping composite materials in Examples 1 to 9 have a damping coefficient of not less than 7.0% at a high temperature (250° C.) and thus have the good vibration-damping property. In addition, it was found that the vibration-damping composite materials in Examples 1 to 9 have a tensile strength of not less than 200 MPa at a high temperature (250° C.) and thus have good mechanical strength.

In contrast, the vibration-damping composite materials in Comparative Examples 1 to 4 have a high damping coefficient but do not have sufficient tensile strength. On the other hand, the vibration-damping composite material in Comparative Example 5 and the laminated damping steel sheet in Comparative Example 6 have high tensile strength but do not have a sufficient damping coefficient.

As described above, it was confirmed that the vibration-damping composite material of the invention, which is provided with a clad material having a base material formed of a zinc-aluminum alloy and metal layers formed of a ferritic stainless steel provided on both surfaces of the base material and in which a total thickness of the metal layers provided on the both surfaces of the base material is not less than 40% and not more than 80% with respect to the thickness of the clad material, has the good vibration-damping property and mechanical strength under the high-temperature environment.

It should be noted that the invention is not intended to be limited to the embodiment and the examples and various kinds of modifications can be implemented without departing from the gist of the invention. Further, please note that all combinations of the features described in the embodiment and examples are not needed to solve the problem of the invention.

What is claimed is:

1. A vibration-damping composite material, comprising:
a clad material that comprises a base material comprising a zinc-aluminum alloy and metal layers each comprising a ferritic stainless steel on both surfaces of the base material,
wherein a total thickness of the metal layers is not less than 40% and not more than 80% of the thickness of the clad material.

2. The vibration-damping composite material according to claim 1, wherein the metal layers comprise a same ferritic stainless steel.

3. The vibration-damping composite material according to claim 1, wherein the metal layers have a same thickness.

4. The vibration-damping composite material according to claim 1, wherein the metal layer comprises one of SUS430, SUS405, SUS409 and SUS430LX.

5. The vibration-damping composite material according to claim 1, wherein the clad material has a thickness of not less than 1 mm and not more than 5 mm.

6. The vibration-damping composite material according to claim 1, wherein the base material comprises an alloy of Zn-22 mass % Al.

7. The vibration-damping composite material according to claim 6, wherein the total thickness of the metal layers is not less than 40% and not more than 65% of the thickness of the clad material.
